(19) United States
(12) Patent Application Publication
(10) Pub. No.: US 2006/0274197 A1
(43) Pub. Date: Dec. 7, 2006

(54) Display apparatus and control method thereof

(75) Inventor: Eun-jong Yoo, Suwon-Si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/316,841

(22) Filed: Dec. 27, 2005

(30) Foreign Application Priority Data
Jun. 7, 2005 (KR) 10-2005-0048609

(51) Int. Cl. H04N 7/08; H04N 11/00

(52) U.S. Cl. 348/465; 348/468; 725/137

(57) ABSTRACT

A display apparatus which receives a signal containing at least one of appendix information and video information, processes and displays the received signal, wherein the display apparatus includes an appendix signal extracting unit which extracts an appendix signal corresponding to the appendix information contained in the received signal; and a controller which reads the appendix information corresponding to the appendix signal that is extracted by the appendix signal extracting unit at a predetermined read-time interval, from the appendix signal extracting unit, and decodes the read appendix information. Thus, a display apparatus and a control method thereof are provided which can effectively read appendix information without supporting an interrupt method for reading the appendix information, and which can thereby display an appendix screen.

### CROSS-REFERENCE TO RELATED APPLICATIONS

This application claims priority from Korean Patent Application No. 10-2005-0048609, filed on Jun. 7, 2005, in the Korean Intellectual Property Office, the disclosure of which is incorporated herein by reference.

### BACKGROUND OF THE INVENTION

1. Field of the Invention

Apparatuses and methods consistent with the present invention relate to a display and a control method thereof, and more particularly, to a display and a control method thereof, which can effectively read appendix information without supporting an interrupt method for reading the appendix information, and can thereby display an appendix screen.

2. Description of the Related Art

A conventional display capable of reproducing appendix information such as a caption comprises a display unit, a video signal receiver to receive a video signal including the appendix information, a decoder to decode the video signal received through the video signal receiver, and a signal processor to process the decoded video signal to be displayed on the display unit.

The process of decoding the appendix information is as follows. In general, the video signal includes the appendix information in the 21^{st} scan line of an odd field and the 284^{th} scan line of an even field. Thus, the decoder extracts an appendix signal corresponding to the appendix information from the even and odd fields of the input video signal, and stores the appendix information of the appendix signal. In this case, the decoder extracts the appendix signal from the even and odd fields on the basis of a vertical synchronization signal of the video signal, and generates a predetermined interrupt signal every time when it extracts the appendix signal. Thus, a predetermined controller for controlling the decoding process reads the stored appendix information of the even and odd fields every time when the interrupt signal is input, and then decodes the read appendix information. Then, the signal processor processes the picture and appendix signals included in the video signal that is decoded and output from the decoder, so that the display unit displays a picture and the appendix information. Here, the signal processor includes an on screen display (OSD) generator to provide OSD appendix information to display the appendix information (e.g., a caption) of the appendix signal on the display unit.

However, the conventional display apparatus can read the appendix information only when it supports an interrupt method that receives the interrupt signal for reading the appendix information. In other words, the conventional display apparatus cannot read the extracted appendix information unless the controller supports the interrupt method. Therefore, there is a problem in that the conventional display apparatus must support the interrupt method to read the appendix information.

### SUMMARY OF THE INVENTION

Accordingly, it is an aspect of the present invention to provide a display apparatus and a control method thereof, which can effectively read appendix information without supporting an interrupt method for reading the appendix information, an can thereby display an appendix screen.

According to an aspect of the present invention, there is provided a display apparatus receiving a signal containing at least one of appendix information and video information, processing and displaying the signal, the display apparatus comprising: an appendix signal extracting unit which extracts an appendix signal corresponding to the appendix information among received signals; and a controller which reads the appendix information corresponding to the appendix signal extracted by the appendix signal extracting unit at a predetermined read-time interval from the appendix signal extracting unit, and decodes the read appendix information.

According to an aspect of the present invention, the appendix signal extracting unit periodically extracts the appendix signal corresponding to the appendix information among the received signals at a predetermined extract-time interval, and updates and stores the appendix information corresponding to the extracted appendix signal.

According to an aspect of the present invention, the controller periodically reads the appendix information stored in the appendix signal extracting unit at the predetermined read-time interval, and decodes the read appendix information.

According to an aspect of the present invention, the predetermined read-time interval is set to be shorter than the predetermined extract-time interval.

According to an aspect of the present invention, the controller periodically reads the appendix information stored in the appendix signal extracting unit at the predetermined read-time interval, determines whether the read appendix information and previously read appendix information are included in the same field, and decodes the read appendix information when the read appendix information and the previously read appendix information are not included in the same field.

According to an aspect of the present invention, the controller determines whether the read appendix information contains valid information when the read appendix information and the previously read appendix information are not included in the same field, and decodes the read appendix information when the read appendix information contains valid information.

According to an aspect of the present invention, the display apparatus further comprises an On Screen Display (OSD) generator which generates an appendix screen corresponding to the appendix information, wherein the controller controls the OSD controller to generate the appendix screen corresponding to the decoded appendix information.

According to an aspect of the present invention, the appendix information comprises at least one of caption information, V-CHIP information and teletext (TTX) information.

According to an aspect of the present invention, the controller reads the appendix information from the appendix signal extracting unit using an Inter-Integrated Circuit (I2C).

According to an aspect of the present invention, there is provided a control method of a display apparatus which receives a signal containing at least one of appendix information and video information, and processes and displays the received signal, the control method comprising: periodically extracting an appendix signal corresponding to the appendix information contained in the received signal at a predetermined extract-time interval; updating and storing the appendix information corresponding to the extracted appendix signal; periodically reading the stored appendix information at a predetermined read-time interval; and decoding the read appendix information.

According to an aspect of the present invention, the predetermined read-time interval is set to be shorter than the predetermined extract-time interval.

According to an aspect of the present invention, the decoding of the read appendix information comprises, determining whether the read appendix information and previously read appendix information are included in the same field; and decoding the read appendix information when the read appendix information and the previously read appendix information are not included in the same field.

According to an aspect of the present invention, the decoding of the read appendix information comprises determining whether the read appendix information contains valid information when the read appendix information and the previously read appendix information are not included in the same field; and decoding the read appendix information when the read appendix information contains valid information.

According to an aspect of the present invention, the control method further comprises generating an appendix screen corresponding to the decoded appendix information and displaying the appendix screen.

According to an aspect of the present invention, the appendix information comprises at least one of caption information, V-CHIP information, and teletext (TTX) information.

### BRIEF DESCRIPTION OF THE DRAWINGS

The above and other aspects of the present invention will become apparent and more readily appreciated from the following description of exemplary embodiments of the present invention, with reference to the accompanying drawings, in which:

FIG. 1 is a control block diagram of a display apparatus according to an exemplary embodiment of the present invention;

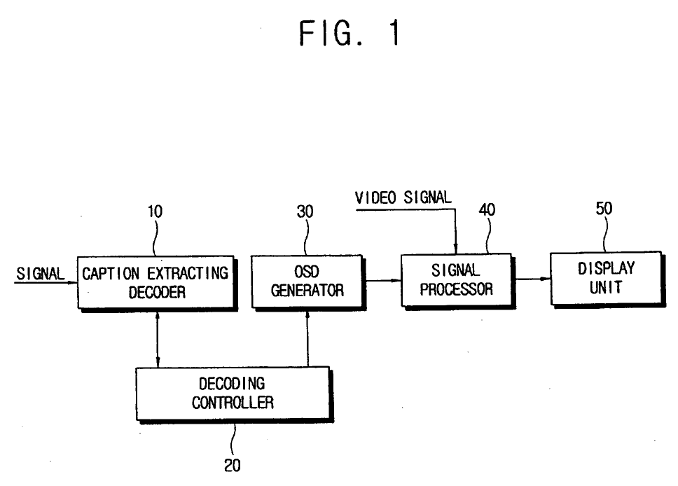

FIG. 2 is a flowchart of a caption extracting decoder of a display apparatus according to an exemplary embodiment of the present invention;

FIG. 3 is a control flowchart of a display apparatus according to an exemplary embodiment of the present invention.

### DETAILED DESCRIPTION OF EXEMPLARY EMBODIMENTS OF THE PRESENT INVENTION

Reference will now be made in detail to exemplary embodiments of the present invention, examples of which are illustrated in the accompanying drawings, wherein like reference numerals refer to like elements throughout. The exemplary embodiments are described below so as to explain the present invention by referring to the figures.

A display apparatus according to an exemplary embodiment of the present invention includes a display unit 50 and a caption extracting decoder 10 which functions as an appendix signal extractor that extracts an appendix signal corresponding to the appendix information from a video signal received at a signal input unit (not shown), which receives a signal containing at least one of appendix information and video information. A display apparatus according to an exemplary embodiment of the present invention further includes a decoding controller 20, as a controller, which periodically reads the appendix information at a predetermined read-time interval and decodes the read information, an On Screen Display (OSD) generator 30, which generates an appendix screen corresponding to the appendix information that is decoded by a control of the decoding controller 20, and a signal processor 40, which processes the appendix screen and a video screen that is processed by a video signal processor (not shown) so that the display unit 50 displays the appendix screen and the video screen thereon.

Herein, the appendix information preferably, but not necessarily, refers to at least one of caption information, V-CHIP information and teletext (TTX) information. Below, configuration of an exemplary embodiment of the present invention will be described supposing that caption data which corresponds to the caption information is input as the appendix information.

The display unit 50, which receives and displays video and caption signals, includes a display panel (not shown) which displays images and captions thereon and a panel driver (not shown) which processes a signal from the signal processor 40 and displays the processed signal thereon. According to this exemplary embodiment, the display unit and the panel driver may be provided such that they correspond to the type of the display.

The signal processor 40 converts a signal that contains at least one of a caption screen signal that is output from the OSD generator 30 and a video signal that is processed by the video signal processor (not shown) into a signal having a format suitable for the display unit 50, and then outputs the converted signal to the display unit 50.

The caption extracting decoder 10 periodically extracts an appendix signal that corresponds to the caption information from the received signal at a predetermined extract-time interval. In other words, the caption extracting decoder 10 extracts caption signals corresponding to the 21 st scan line of an odd field and the 284th scan line of an even field, and then stores the caption information of the extracted caption signals. Moreover, the caption extracting decoder 10 extracts the caption signals from the even and odd fields on the basis of a vertical synchronization signal of the received signal. For example, the caption extracting decoder 10 extracts the caption signal every 16 ms when the received signal is an Nation Television System Committee (NTSC) signal, and updates and stores the caption information every 16 ms.

The decoding controller 20 periodically reads the caption information stored in the caption extracting decoder 10 at a predetermined read-time interval. Further, the predetermined read-time interval is preferably, but not necessarily, shorter than the predetermined extract-time interval (i.e., 16 ms). For example, the decoding controller 20 may read the caption information that is stored in the caption extracting decoder 10 every 10 ms. It is preferred, but not necessary, that the decoding controller 20 reads the caption information using an Inter-Integrated Circuit (12C) from the caption extracting decoder 10. Thus, the decoding controller 20 reads caption information extracted by the caption extracting decoder 10 without receiving an interrupt signal that is generated every time when it extracts a caption signal.

The decoding controller 20 determines whether the read caption information and caption information read just before are included in the same field. In other words, the decoding controller 20 determines whether currently read caption information is included in the even field when the decoding controller 20 previously read caption information included in the odd field, and determines whether currently read caption information is included in the odd field when the decoding controller 20 previously read caption information included in the even field.

The foregoing determination is provided for preventing the decoding controller 20, which reads the caption information, for example, every 10 ms, from reading and decoding caption information which is the same as previously read caption information when the caption extracting decoder 10 does not store updated caption information because the extract-time interval (16 ms) has not passed.

When it is determined that the current caption information and previous caption information are not included in the same field as a result of such a determination, the decoding controller 20 determines whether the current caption information is valid. In other words, the decoding controller 20 extracts a start bit of the current caption information to determine whether the current caption information is displayable. When the current caption information is determined as valid caption information, the decoding controller 20 decodes the current caption information and outputs the decoded caption information to the OSD generator 30 so as to control the OSD generator 30 to display a caption screen which corresponds to the caption information. Preferably, but not necessarily, the decoding controller 20 can be achieved by a central processing unit (CPU).

The decoding controller 20 of the display apparatus according to an exemplary embodiment of the present invention periodically reads caption information from the caption extracting decoder 10 at a time interval (e.g., 10 ms) that is shorter than a time interval (e.g., 16 ms) at which the caption information is updated, and compares currently read caption information and previously read caption information for decoding. This process has the same effect of reading caption information based on a synchronized signal. Therefore, the display apparatus according to an exemplary embodiment of the present invention can read, decode and display caption information through general hardware without supporting a specific interrupt method of the caption extracting decoder 10.

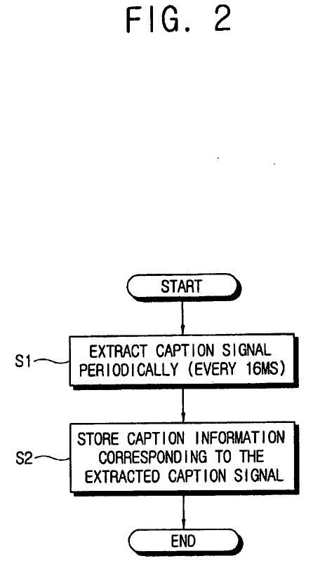

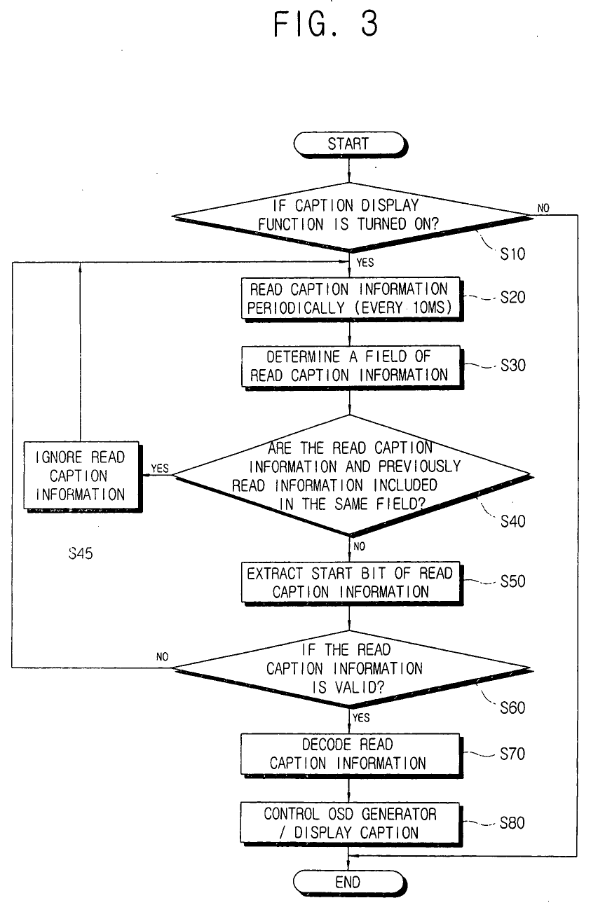

Below, a control process of the display apparatus according to an exemplary embodiment of the present invention will be described with reference to FIG. 2 and FIG. 3.

First, a caption extraction process of the caption extracting decoder 10 is described with reference to FIG. 2. In operation S1, the caption extracting decoder 10 periodically extracts a caption signal that corresponds to the 21st scan line of the odd field and the 284th scan line of the even field among video signals on the basis of a vertical synchronization signal at every 16 ms. Further, in operation S2, the caption extracting decoder 10 updates information on the caption signal and stores caption information corresponding to the extracted caption signal. That is, the caption extracting decoder 10 updates caption information every 16 ms.

The control process of the display apparatus according to an exemplary embodiment of the present invention is described in more detail with reference to FIG. 3.

In operation S10, the decoding controller 20 checks whether the state of a caption display function is turned on. If the caption display function is currently turned on, then in operation S20, the decoding controller 20 periodically reads the caption information that is stored in the caption extracting decoder 10 every 10 ms. In operation S30, referring to a result of a determination, the decoding controller 20 determines field information of the read caption information. Further, in operation S40, referring to a result of the determination, the decoding controller 20 determines whether a field in which currently read caption information is included and a field in which previously read caption information is included are the same. When it is determined that the current caption information and the previous caption information are included in the same field, the decoding controller 20 ignores the current caption information in operation S45, and prepares to read the caption information for the next period. However, when the current caption information and the previous caption information are not included in the same field, the decoding controller 20 detects a start bit of the currently read caption information in operation S50, and then determines whether the read caption information is valid on the basis of the start bit in operation S60. If the read caption information is determined to be valid, the decoding controller 20 decodes the read caption information in operation S70. In operation S80, the decoding controller 20 then outputs the decoded caption information to the OSD generator 30 so as to control the OSD generator to generate a caption screen corresponding to the caption information and to display the caption screen.

As described above, the caption extracting decoder 10 periodically reads caption information at a given interval (e.g., every 10 ms) that is shorter than a given interval (e.g., every 16 ms) at which the caption information is updated, and decodes the read caption information by comparing it with previously read caption information. This process yields the same result as reading caption information on the basis of a vertical synchronization signal according to the display apparatus and the control method thereof. Therefore, the display apparatus according to the exemplary embodiment of the present invention can read, decode and display caption information using general hardware without supporting a specific interrupt method of the caption extracting decoder 10.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus which receives a signal including appendix information, the display apparatus comprising:
an appendix signal extracting unit which extracts an appendix signal corresponding to the appendix information included in the received signal; and
a controller which reads appendix information corresponding to the appendix signal that is extracted by the appendix signal extracting unit at a predetermined read-time interval, from the appendix signal extracting unit, and decodes the read appendix information.

2. The display apparatus according to claim 1, wherein the appendix signal extracting unit periodically extracts the appendix signal corresponding to the appendix information included in the received signal at a predetermined extract-time interval, and updates and stores the appendix information corresponding to the extracted appendix signal.

3. The display apparatus according to claim 2, wherein the controller periodically reads the appendix information that is stored in the appendix signal extracting unit at the predetermined read-time interval, and decodes the read appendix information.

4. The display apparatus according to claim 3, wherein the display apparatus is configured such that the predetermined read-time interval is set to be shorter than the predetermined extract-time interval.

5. The display apparatus according to claim 4, wherein the controller determines whether the read appendix information and previously read appendix information are included in a same field, and decodes the read appendix information if the read appendix information and the previously read appendix information are not included in the same field.

6. The display apparatus according to claim 5, wherein the controller determines whether the read appendix information contains valid information if the read appendix information and the previously read appendix information are not included in the same field, and decodes the read appendix information if the read appendix information contains valid information.

7. The display apparatus according to claim 6, further comprising an On Screen Display (OSD) generator which generates an appendix screen, wherein the controller controls the OSD generator to generate the appendix screen such that the appendix screen corresponds to the decoded appendix information.

8. The display apparatus according to claim 7, wherein the appendix information comprises at least one of caption information, V-CHIP information and teletext (TTX) information.

9. The display apparatus according to claim 8, wherein the controller reads the appendix information that is stored in the appendix signal extracting unit using an Inter-Integrated Circuit (12C).

10. A control method for a display apparatus, the control method comprising:
receiving a signal including appendix information;
periodically extracting an appendix signal corresponding to the appendix information included in the received signal at a predetermined extract-time interval;
updating and storing appendix information corresponding to the extracted appendix signal;
periodically reading the stored appendix information at a predetermined read-time interval; and
decoding the read appendix information.

11. The control method according to claim 10, wherein the predetermined read-time interval is set to be shorter than the predetermined extract-time interval.

12. The control method according to claim 11, wherein the decoding the read appendix information comprises:
determining whether the read appendix information and previously read appendix information are included in a same field; and
decoding the read appendix information if the read appendix information and the previously read appendix information are not included in the same field.

13. The control method according to claim 12, wherein the decoding the read appendix information further comprises:
determining whether the read appendix information contains valid information if the read appendix information and the previously read appendix information are not included in the same field; and
decoding the read appendix information if the read appendix information contains valid information.

14. The control method according to claim 13, further comprising:
generating an appendix screen corresponding to the decoded appendix information; and
displaying the appendix screen.

15. The control method according to claim 14, wherein the appendix information comprises at least one of caption information, V-CHIP information, and teletext (TTX) information.

16. The control method according to claim 14, wherein the appendix screen comprises an On Screen Display (OSD).

17. The control method according to claim 15, wherein the appendix information is read using an Inter-Integrated Circuit (I2C).
